(19) United States
(12) Patent Application Publication
(10) Pub. No.: US 2009/0097363 A1
(43) Pub. Date: Apr. 16, 2009

(54) MEETING CLOCK

(75) Inventor: Anders NYBERG, Malmo (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(73) Assignee: SONY ERICSSON MOBILE COMMUNICATIONS AB, Lund (SE)

(21) Appl. No.: 11/872,127

(22) Filed: Oct. 15, 2007

(51) Int. Cl. G04C 19/00; G04B 47/00

(52) U.S. Cl. 368/251

(57) ABSTRACT

A method and apparatus for displaying appointment information on a face of a clock is disclosed. When the clock receives appointment information, the appointment information is stored in a memory. The appointment information for the next 12 hours is then displayed around the face of the clock.

### TECHNICAL FIELD OF THE INVENTION

The present invention relates to a watch or time piece and more particularly to a method and apparatus for displaying meeting information on a watch or time piece.

### DESCRIPTION OF RELATED ART

Digital watches have evolved greatly over the past 30 years. From simple time keeping functions, the capabilities of the digital watch have continued to expand to include multiple features such as timers, alarms, sports-related functions, etc. In recent years, watches have become capable of serving as personal information managers and wireless phones.

Some watches are now able to communicate with other devices wirelessly using Bluetooth and other wireless systems and protocols. Bluetooth is basically a wireless personal area network technology, which is an open standard for short-range transmission of digital voice and data between predominately mobile devices, such as laptops, Personal Digital Assistants (PDAs), and mobile phones, and also between mobile devices and stationary devices, and between stationary devices, such as printers, computers, fax machines and so on. Bluetooth supports point-to-point and multipoint applications. Bluetooth typically provides up to 720 Kbps data transfer within a range of 10 meters and up to 100 meters with a power boost. Bluetooth uses omni-directional radio waves that can transmit through walls and other non-metal barriers in the unlicensed 2.4 GHz band.

Presently some watches use Bluetooth to communicate with and control the operation of other Bluetooth enabled devices, such as computers, PDAs, cell phones and music devices. For example, the watch 100 may have at least one display screen 110 on which various information can be displayed as illustrated in FIG. 1. The display screen 110 may indicate that an email has been received by an external PC, PDA or cell phone or that a call is being received by a cell phone. Furthermore, the watch 100 may have controls 120 for controlling the operation (pause, skip, volume) of an external music device.

In addition, the display screen 110 may display information such as a personal calendar received from an external device. Personal calendars typically include a schedule of meetings for each day. In order to review the schedule, a user would have to scroll through the calendar while it is being displayed on the display screen 110. This may be a problem for several reasons. First, the display screen 110 may be very small so it may be hard to read. In addition, may take a while to scroll through the calendar on such a small display.

Thus, there is a need for a method and apparatus for displaying calendar information in such a manner that the user can quickly determine the timing of various meetings.

### SUMMARY OF THE INVENTION

According to some embodiments of the invention, a method for displaying appointment information on a clock is disclosed wherein the method comprises the steps of: receiving appointment information from an external device; storing said received appointment information; and displaying appointment for the next 12 hours around the face of the clock.

According to another embodiment of the invention a clock is disclosed comprising a clock face for displaying time; a receiver for receiving appointment information; a memory for storing the received appointment information; a first display for displaying appointment information for 12 hours around the face of the clock.

Further embodiments of the invention are defined in the dependent claims.

It is an advantage of embodiments of the invention that appointment information can be displayed around the face of the watch or clock in such a manner that a user can easily determine his/her appointment schedule for the next 12 hours.

### BRIEF DESCRIPTION OF THE DRAWINGS

Further objects, features and advantages of embodiments of the invention will appear from the following detailed description of the invention, reference being made to the accompanying drawings, in which:

FIG. 1 illustrates a known digital watch;

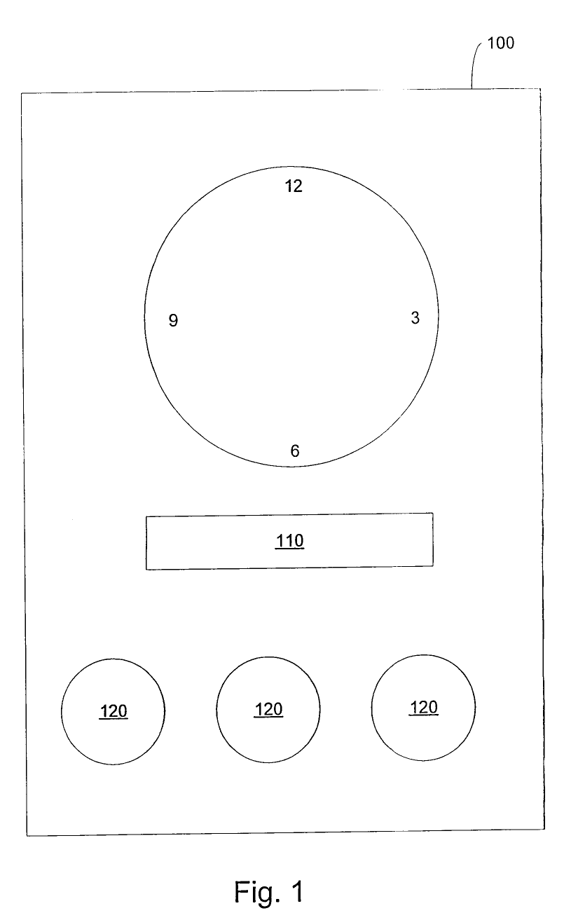

FIG. 2 illustrates a wireless communication system for use by the invention;

FIG. 3 illustrates a digital watch according to one embodiment of the invention;

FIG. 4 is a flow chart describing the operation of the watch according to one embodiment of the invention; and

FIG. 5 illustrates a face of a clock displayed on an electronic device according to one embodiment of the invention.

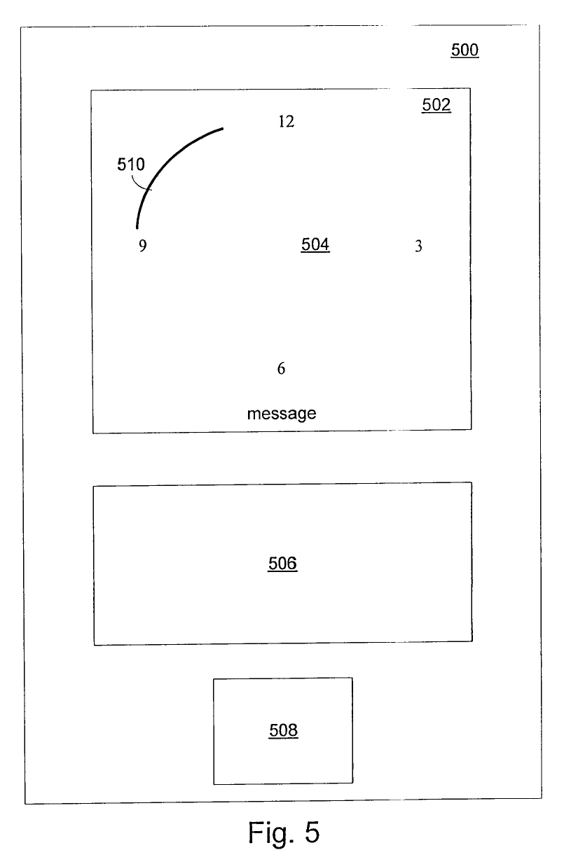

### DETAILED DESCRIPTION OF EMBODIMENTS

Specific illustrative embodiments of the invention will now be described with reference to the accompanying drawings. This invention may, however, be embodied in many different forms and should not be construed as limited to the embodiments set forth herein. Rather, the disclosed embodiments are provided so that this specification will be thorough and complete, and will fully convey the scope of the invention to those skilled in the art. The terminology used in the detailed description of the particular embodiments illustrated in the accompanying drawings is not intended to be limiting of the invention. Furthermore, in the drawings like numbers refer to like elements.

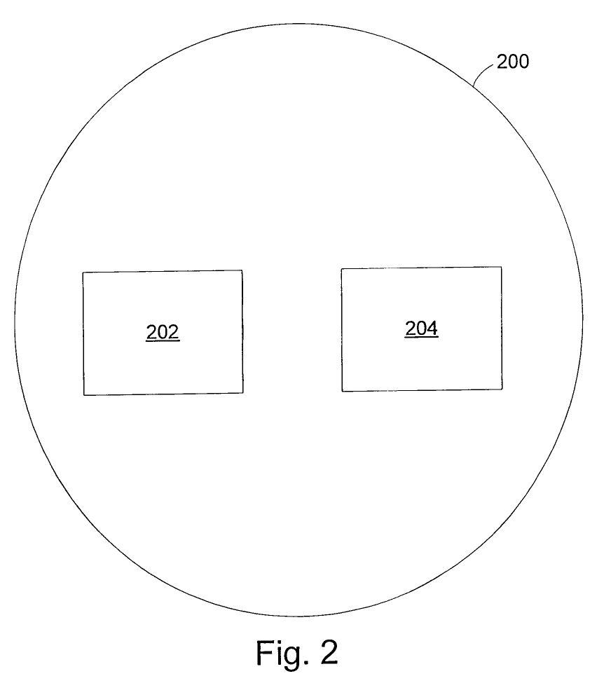

FIG. 2 illustrates a wireless communication system 200 within which the invention may operate. While the invention will now be described as using a Bluetooth wireless system, it will be understood by those skilled in the art that the invention can operate in various wireless systems and the invention is not limited thereto. In this embodiment, a clock or watch 202 is in communication with an external electronic device 204. The external electronic device 204 may be a computer, PDA, cell phone, etc., and the invention is not limited thereto. The external electronic device 204 transmits appointment information, e.g. a schedule of meetings and telephone calls, for the particular user to the watch 202 where the appointment information will be displayed as will be explained in more detail below. Thus, a person's appointment schedule stored on the external electronic device 204 is copied over to the watch 202.

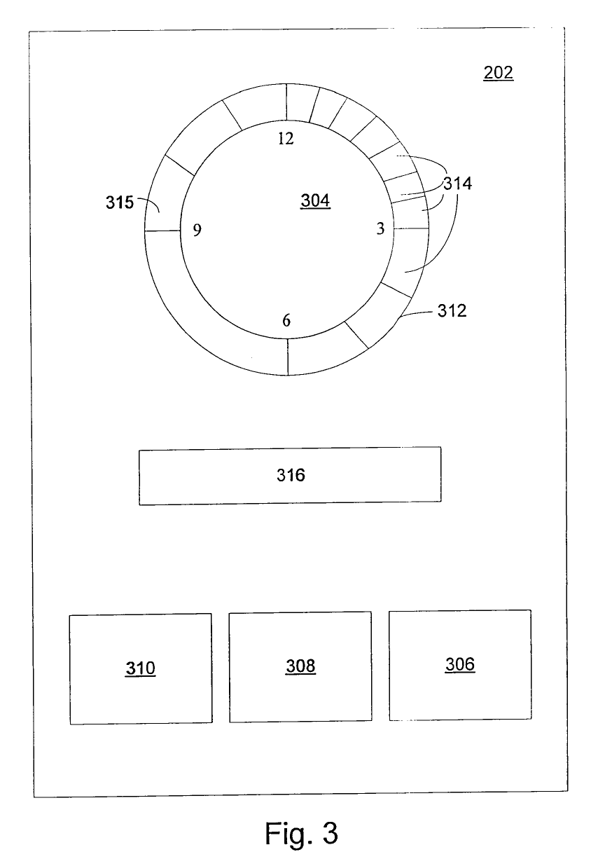

FIG. 3 illustrates a watch 202 according to one embodiment of the invention. The watch 202 has a typical watch face 304 on which the time is displayed. The watch face may have the traditional layout illustrated in FIG. 3 but the invention is not limited thereto. The watch 202 comprises a transceiver 306 for communicating with one or more external electronic devices 204. The transceiver 306 is connected to a microprocessor 308 which is programmed to perform various functions on the watch 202. The microprocessor 308 is connected to a memory 310 and a plurality of displays 312 and 316 and may be connected to other parts of the watch which are not illustrated. The display 312 is located around the perimeter of the watch face 304 and the display is divided into a plurality of segments 314. The time segments 314 represent predetermined periods of time, e.g. 15 minutes, 30 minutes, 60 minutes, etc. and the invention is not limited thereto. The time segments 314 are positioned on the watch face 304 in such a manner so that each segment represents a specific time period which corresponds to its position on the watch face. For example, the time segment 315 which is located between the 9 and the 10 on the watch face represents the time period from 9:00 am to 10:00 am or 9:00 pm to 10:00 pm depending on the time of day.

Each time segment 314 may display a color or not to represent different things. For example, a time segment 314 may display the color red to represent that an appointment has been scheduled for that time period. The time segment 314 may not display any color or may display a second color, for example green, to indicate periods of time which are free from scheduled appointments, but the invention is not limited thereto. Furthermore, different colors may be used to indicate different types of meetings such as, on-site meetings, off-site meetings, telephone calls, etc. In addition, the displayed color may be personally selected by the user to customize the watch 202.

The watch 202 may also has a second display 316. According to one embodiment of the invention, the display 316 may be used to display information pertaining to the next scheduled meeting. For example, the information may include the time and location of a meeting and/or the name of a person, and/or a telephone number and the invention is not limited thereto.

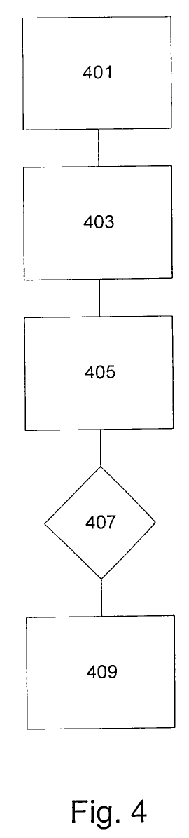

The operation of the watch according to one embodiment of the invention will now be described with reference to FIG. 4. As mentioned above, the external electronic device 204 periodically transmits the appointment information to the watch 202, for example, when the watch is within the wireless system or through periodic updates. When the watch 202 receives the appointment information in step 401, the watch 202 saves the appointment information in the memory 310 in step 403. The microprocessor 308 analyzes the appointment information and then displays the appointment information on the face of the watch 202 by illuminating the time segments 314 of the display 312 in the appropriate manner in step 405. The microprocessor 308 monitors the time so that when a segment of time expires, in step 407, the microprocessor 308 changes the status of the segment to reflect appointment information approximately 12 hours later in step 409.

According to another embodiment of the invention, the watch 202 may generate an alert at a predetermined period of time before the next scheduled appointment. For example, the watch may produce a vibrating alert or an audio alert 5, 10 or 15 minutes prior to the next scheduled appointment. Alternatively, the watch 202 may begin flashing a message on the second display 316 to provide the alert.

According to another embodiment of the invention, a user may manually enter appointment information into a calendar program loaded on the watch. The appointment information is then stored and displayed in the same manner described above.

According to another embodiment of the invention, appointment information may be displayed on virtual clocks which are displayed as a screensaver or standby application on an electronic device 500 such as a cell phone, PDA, computer, etc. and the invention is not limited thereto. In this embodiment, the electronic device 500 has a display 502 which displays a virtual watch face 504 as a screensaver or standby application. The appointment information may either be received from another external electronic device, via for example, a wireless system, or manually inserted into the electronic device using the keys 506. A microprocessor 508 in the electronic device 500 interprets the appointment information and displays the scheduled meetings on the display 502 by overlaying colored segments 510 on the virtual watch face during the time periods of the scheduled meetings. In addition, a description of the next meeting may be displayed below the virtual watch face 504 on the display 502.

Although the embodiments of the present invention described with reference to the drawings comprise a watch or timepiece 202 and processes performed in the watch or timepiece 202, the invention also extends to a computer program product, which enables implementation of the method and functions described herein. The invention may be carried out when the computer program product is loaded and executed in a system having computer capabilities. Computer program, software program, program product, or software, in the present context mean any expression, in any programming language, code or notation, of a set of instructions intended to cause a system having a processing capability to perform a particular function directly or after conversion to another language, code or notation.

The present invention has been described above with reference to specific embodiments. However, other embodiments than the above described are equally possible within the scope of the invention. Different method steps than those described above, performing the method by hardware or software or a combination of hardware and software, may be provided within the scope of the invention. It should be appreciated that the different features and steps of the invention may be combined in other combinations than those described. The scope of the invention is only limited by the appended patent claims.

What is claimed is:

1. A method for displaying appointment information on a face of a clock, comprising the steps of:
receiving appointment information;
storing the received appointment information;
displaying the appointment information for the next 12 hours on a first display around the face of the clock.

2. A method according to claim 1, wherein scheduled appointments are displayed in a first color.

3. A method according to claim 2, wherein available time is displayed in a second color.

4. A method according to claim 1, further comprising the steps of:
displaying a description of the next scheduled appointment on a second display on the face of the clock.

5. A method according to claim 1, further comprising the steps of:
generating an alert a predetermined period of time before the next scheduled appointment.

6. A method according to claim 5, wherein the alert is a vibrating alert.

7. A method according to claims 1, wherein the received appointment information is received from an external device.

8. A method according to claim 1, wherein the first display is divided into a plurality of time segments.

9. A method according to claim 8, wherein each time segment represents one hour.

10. A method according to claim 8, wherein each time segment represents 30 minutes.

11. A method according to claim 8, wherein each time segment represents 15 minutes.

12. A method according to claim 8, wherein each time segment represents a period of time related to its relative location on the face of the watch.

13. A method according to claim 8, wherein at the end of a time segment the appointment information on the watch is updated.

14. A method according to claim 1, wherein the clock is a watch.

15. A method according to claim 1, wherein the clock is a virtual clock being displayed on an electronic device.

16. A clock comprising:
a clock face for displaying time;
a receiver for receiving appointment information;
a memory for storing the received appointment information;
a first display for displaying appointment information for the next 12 hours around the face of the clock.

17. A clock according to claim 16, wherein scheduled appointments are displayed in a first color.

18. A clock according to claim 17, wherein available time is displayed in a second color.

19. A clock according to claim 16, further comprising:
a second display for displaying a description of the next scheduled appointment on the face of the clock.

20. A clock according to claim 16, further comprising:
means for generating an alert a predetermined period of time before the next scheduled appointment.

21. A clock according to claim 20, wherein the alert is a vibrating alert.

22. A clock according to claims 16, wherein the received appointment information is received from an external device.

23. A clock according to claim 16, wherein the first display is divided into a plurality of time segments.

24. A clock according to claim 23, wherein each time segment represents one hour.

25. A clock according to claim 23, wherein each time segment represents 30 minutes.

26. A clock according to claim 23, wherein each time segment represents 15 minutes.

27. A clock according to claim 23, wherein each time segment represents a period in time related to its location on the face of the watch.

28. A clock according to claim 23, wherein at the end of a time segment the appointment information on the watch is updated.

29. A clock according to claim 16, wherein the clock is a watch.

30. A clock according to claim 16, wherein the clock is a virtual clock being displayed on an electronic device.

31. A computer program product comprising program instructions for causing a computer system to perform the method of claim 1 when said program is run on a computer system in a clock.

32. The computer product according to claim 31, embodied on a record medium, stored in a computer memory, embodied in a read-only memory, or carried on an electrical carrier signal.

33. A computer program product comprising a computer readable medium, having thereon: computer program code means wherein said program is loaded, to make the computer system execute the method of claim 1.
